(19) United States
(12) Patent Application Publication
(10) Pub. No.: US 2021/0309306 A1
(43) Pub. Date: Oct. 7, 2021

(54) TEMPORARY STABILIZER SYSTEM AND METHOD OF USE

(71) Applicant: Mitchell Strahan, Arlington, TX (US)

(72) Inventor: Mitchell Strahan, Arlington, TX (US)

(21) Appl. No.: 16/801,983

(22) Filed: Feb. 26, 2020

(51) Int. Cl. B62D 37/02; B62D 35/00; B60R 11/00

(52) U.S. Cl. CPC B62D 37/02; B60R 2011/0056; B60R 11/00; B62D 35/007

(57) ABSTRACT

A temporary stabilizer system allows a spoiler or wing to be removably attached to a car or some other vehicle. The stabilizer then generates downforce relative to the velocity of the air passing around it to hold the car to the ground and increase the control thereof. The stabilizer is attached by suction cups or by an artificial suction force.

### BACKGROUND

### 1. Field of the Invention

The present invention relates generally to vehicle stabilization systems, and more specifically, to a temporary or removable stabilizer system that is removably attached to a car or other vehicle to improve the downforce experienced by the tires of the vehicle.

### 2. Description of Related Art

Vehicle stabilization systems are well known in the art and are effective means to improve the handling or responsiveness of a vehicle. For example, spoilers or wings are permanently attached to the rear of cars, trucks and other vehicles to provide a downward force on the rear of the vehicle as the speed thereof increases to ensure that the vehicle remains in contact with the road or other driving surface.

One of the problems commonly associated with conventional spoilers is their limited use. For example, the spoiler or wing is only beneficial at higher speeds of travel and is not needed at lower speeds. Commonly, high-speed driving will only occur at limited and predictable times. It would be beneficial to allow for the use of the spoiler or wing when needed and not at other times.

Additionally, removal of the wing or spoiler leaved damage to the vehicle were the fasteners penetrated the body of the vehicle. Also, when bonded to the surface leaves residue or damage to the surface coatings on the vehicle.

Accordingly, although great strides have been made in the area of vehicle stabilization systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1A and 1B are side views of temporary stabilizer in accordance with a preferred embodiment of the present application;

FIG. 2 is a side view of the stabilizer of FIGS. 1A and 1B;

FIG. 3 is a side view of an alternative embodiment of the stabilizer of FIG. 2;

FIG. 4 is a diagram of an alternative embodiment of the system of FIGS. 1A and 1B.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional vehicle stabilization systems. Specifically, the invention of the present application enables the removal or a spoiler or wing from a vehicle without causing or leaving damage behind. In addition, the system of the present invention is able to be efficiently attached and removed from a vehicle. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

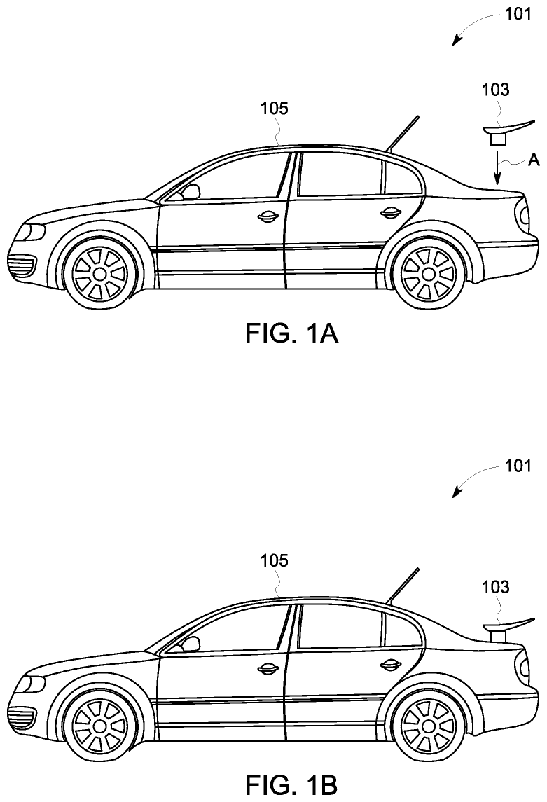

Referring now to the drawings wherein like reference characters identify corresponding or similar elements throughout the several views, FIGS. 1A and 1B depict side views of a temporary stabilizer system in accordance with a preferred embodiment of the present application. It will be appreciated that system 101 overcomes one or more of the above-listed problems commonly associated with conventional vehicle stabilization systems.

In the contemplated embodiment, system 101 includes a detachable wing 103 or other aerodynamic body attached to a car 105 or vehicle as depicted by motion A. In use, the detachable wing 103 is adhered to the rear surface 107 of the car 105. When attached, the detachable wing 103 channels the air passing around it to create a downforce on the car 103.

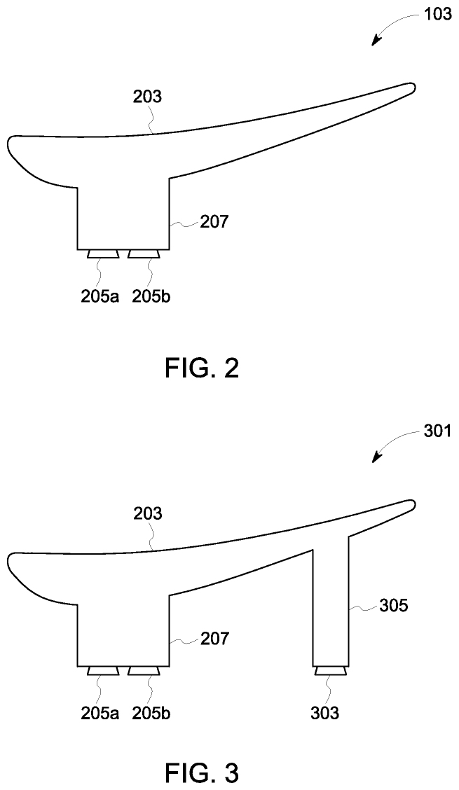

As depicted in FIG. 2, the detachable wing 103 includes a body 203 configured to direct and take advantage of an airflow passing thereabout. The body 203 is attached to the car 105 via a plurality of suction devices 205 attached to a support 207

It should be appreciated that one of the unique features believed characteristic of the present application is that the suction devices 205 allow the detachable wing 103 to be attached to and removed from a vehicle such as a car 105.

Referring now to FIG. 3 an alternative embodiment of the detachable wing 103 is depicted. Embodiment 301 includes similar features as detachable wing 103 wherein a secondary support 305 is located apart from the support 207 and includes a suction device 303. It will be understood and appreciate that any method of connecting the body 203 to the suction devices 205, 303 is contemplated.

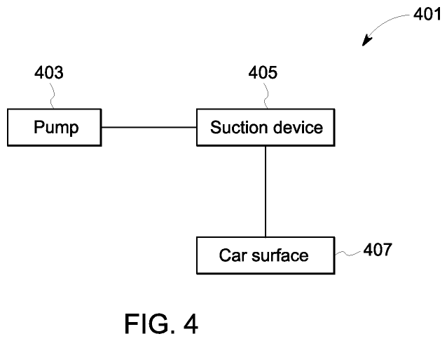

Referring now to FIG. 4 an alternative embodiment of the suction devices is depicted. Embodiment 401 includes the creation of a vacuum such as through a pump 403, that is transferred into a suction force via the suction device 405 that then holds the system to the outer surface of the car.

A method of increasing the stability of a car includes selecting a wing to attach to a car, attaching the wind through suction force, driving the car, allowing the wind to stabilize the car, stopping the car and releasing the suction to remove the wing from the car.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A temporary stabilizer system comprising:
at least one aerodynamic body attached to at least one suction device via at least one support;
wherein the suction devices adhere the at least one aerodynamic body to a vehicle;
wherein the aerodynamic body creates downforce via the fluid passing thereabout.

2. The system of claim 1 wherein the at least one aerodynamic body is attached to the vehicle by a machine created vacuum or force.

3. A method of stabilizing a vehicle, comprising:
selecting a wing to attach to a car;
attaching the wind through suction force;
driving the car;
allowing the wind to stabilize the car;
stopping the car; and
releasing the suction to remove the wing from the car.
